(19) United States
(12) Patent Application Publication
(10) Pub. No.: US 2026/0180840 A1
(43) Pub. Date: Jun. 25, 2026

(54) FREQUENCY SHIFTING IN LOW POWER DEVICES

(71) Applicant: QUALCOMM Incorporated, San Diego, CA (US)

(72) Inventors: Zhikun WU, Beijing (CN); Ahmed ELSHAFIE, San Diego, CA (US); Wei YANG, San Diego, CA (US); Yuchul KIM, San Diego, CA (US); Huilin XU, Temecula, CA (US); Linhai HE, San Diego, CA (US); Wanshi CHEN, San Diego, CA (US); Peter GAAL, San Diego, CA (US)

(21) Appl. No.: 19/128,935

(22) PCT Filed: Jan. 19, 2023
(86) PCT No.: PCT/CN2023/073034

§ 371 Date: May 9, 2025

(51) Int. Cl. H04L 27/16

(52) U.S. Cl. CPC H04L 27/16

(57) ABSTRACT

Methods, systems, and devices for wireless communications are described. A radio frequency identification (RFID) tag may receive, from a first wireless device, a continuous wave via a first set of frequency resources and in accordance with a set of transmission parameters. In some examples, the continuous wave may include a continuous waveform for activation of the RFID tag. Based on receiving the continuous waveform for activation, the RFID tag may modulate the continuous wave with data and send, via a second set of frequency resources, a backscattered signal of the continuous wave based on modulating the continuous wave with data, where the second set of frequency resources may be shifted in frequency relative to the first set of frequency resources. In some examples, the backscattered signal may be sent to the first wireless device. In some other examples, the backscattered signal may be sent to a third wireless device.

### CROSS REFERENCE

The present Application for Patent is a 371 national phase filing of International Patent Application No.: PCT/CN2023/073034 by WU et al., entitled “FREQUENCY SHIFTING IN LOW POWER DEVICES,” filed Jan. 19, 2023, assigned to the assignee hereof, and expressly incorporated by reference herein.

### FIELD OF TECHNOLOGY

The following relates to wireless communications, including frequency shifting in low power devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). In some wireless communications systems, a UE may communicate with or may be a radio frequency identification (RFID) tag.

### SUMMARY

The described techniques relate to improved methods, systems, devices, and apparatuses that support frequency shifting in low power devices. For example, the described techniques provide for a radio frequency identification (RFID) tag to perform frequency shifting in order to send a backscattered signal. For example, the RFID tag may receive, from a first wireless device, a continuous wave via a first set of frequency resources, where the continuous wave may include a continuous waveform for activation of the RFID tag. Based on receiving the continuous waveform for activation, the RFID tag may modulate the continuous wave (for conveying data) and send, via a second set of frequency resources, a backscattered signal of the continuous wave based that includes or indicates the modulated data. In such examples, the second set of frequency resources may be shifted in frequency relative to the first set of frequency resources.

A method for wireless communication at a first wireless device is described. The method may include transmitting, to a second wireless device (e.g., RFID tag), a continuous wave via a first set of frequency resources and in accordance with a set of transmission parameters, where the continuous wave includes a continuous waveform for activation of the second wireless device and receiving, from the second wireless device and via a second set of frequency resources, a backscattered signal of the continuous wave, where the second set of frequency resources is shifted in frequency relative to the first set of frequency resources.

An apparatus for wireless communication at a first wireless device is described. The apparatus may include a processor, memory coupled with the processor, and instructions stored in the memory. The instructions may be executable by the processor to cause the apparatus to transmit, to a second wireless device, a continuous wave via a first set of frequency resources and in accordance with a set of transmission parameters, where the continuous wave includes a continuous waveform for activation of the second wireless device and receive, from the second wireless device and via a second set of frequency resources, a backscattered signal of the continuous wave, where the second set of frequency resources is shifted in frequency relative to the first set of frequency resources.

Another apparatus for wireless communication at a first wireless device is described. The apparatus may include means for transmitting, to a second wireless device, a continuous wave via a first set of frequency resources and in accordance with a set of transmission parameters, where the continuous wave includes a continuous waveform for activation of the second wireless device and means for receiving, from the second wireless device and via a second set of frequency resources, a backscattered signal of the continuous wave, where the second set of frequency resources is shifted in frequency relative to the first set of frequency resources.

A non-transitory computer-readable medium storing code for wireless communication at a first wireless device is described. The code may include instructions executable by a processor to transmit, to a second wireless device, a continuous wave via a first set of frequency resources and in accordance with a set of transmission parameters, where the continuous wave includes a continuous waveform for activation of the second wireless device and receive, from the second wireless device and via a second set of frequency resources, a backscattered signal of the continuous wave, where the second set of frequency resources is shifted in frequency relative to the first set of frequency resources.

Some examples of the method, apparatuses, and non-transitory computer-readable medium described herein may further include operations, features, means, or instructions for receiving, from a network entity, a message including an indication to communicate with the second wireless device, a quantity of resource blocks (RBs) to use in the first set of frequency resources, a target transmission power, a target reception power, a classification of the second wireless device, or a combination thereof, where transmitting the continuous wave via the first set of frequency resources may be based on the message.

Some examples of the method, apparatuses, and non-transitory computer-readable medium described herein may further include operations, features, means, or instructions for receiving a message including a capability of the second wireless device to perform frequency shifting, where receiving the backscattered signal via the second set of frequency resources shifted in frequency relative to the first set of frequency resources may be based on the message.

Some examples of the method, apparatuses, and non-transitory computer-readable medium described herein may further include operations, features, means, or instructions for receiving a message indicating a frequency shift value of the second set of frequency resources, where the second set of frequency resources may be shifted in frequency relative to the first set of frequency resources based on the frequency shift value.

Some examples of the method, apparatuses, and non-transitory computer-readable medium described herein may further include operations, features, means, or instructions for transmitting, to a third wireless device, an indication of the first set of frequency resources used for the continuous wave, a frequency shift value, or both.

Some examples of the method, apparatuses, and non-transitory computer-readable medium described herein may further include operations, features, means, or instructions for performing channel estimations on a channel between the first wireless device and the second wireless device based on the continuous wave and performing time and frequency corrections to decode the backscattered signal based on performing the channel estimations.

In some examples of the method, apparatuses, and non-transitory computer-readable medium described herein, the first set of frequency resources may be contiguous in frequency and the second set of frequency resources may be shifted in frequency relative to the first set of frequency resources by a frequency shift value that may be greater than a quantity of RBs of the first set of frequency resources.

In some examples of the method, apparatuses, and non-transitory computer-readable medium described herein, the first set of frequency resources may be non-contiguous in frequency and the second set of frequency resources may be shifted in frequency relative to the first set of frequency resources by a frequency shift value that may be less than a spacing between RBs of the first set of frequency resources.

In some examples of the method, apparatuses, and non-transitory computer-readable medium described herein, a quantity of RBs in the first set of frequency resources may be based on the set of transmission parameters and the set of transmission parameters include a target transmission power, a target reception power, a power spectral density (PSD) constraint, or a combination thereof.

In some examples of the method, apparatuses, and non-transitory computer-readable medium described herein, a quantity of RBs in the first set of frequency resources may be based on a classification of the second wireless device.

In some examples of the method, apparatuses, and non-transitory computer-readable medium described herein, the classification of the second wireless device includes one of a passive classification, a semi-passive classification, a semi-active classification, or an active classification.

In some examples of the method, apparatuses, and non-transitory computer-readable medium described herein, the second set of frequency resources may be shifted in frequency relative to the first set of frequency resources based on a frequency shift value and the frequency shift value may be preconfigured at the first wireless device.

A method for wireless communication at a second wireless device is described. The method may include receiving a continuous wave via a first set of frequency resources and in accordance with a set of transmission parameters, where the continuous wave includes a continuous waveform for activation of the second wireless device, modulating the continuous wave with data based on the continuous waveform for activation of the second wireless device, and sending, via a second set of frequency resources, a backscattered signal of the continuous wave based on modulating the continuous wave with data, where the second set of frequency resources is shifted in frequency relative to the first set of frequency resources.

An apparatus for wireless communication at a second wireless device is described. The apparatus may include a processor, memory coupled with the processor, and instructions stored in the memory. The instructions may be executable by the processor to cause the apparatus to receive a continuous wave via a first set of frequency resources and in accordance with a set of transmission parameters, where the continuous wave includes a continuous waveform for activation of the second wireless device, modulate the continuous wave with data based on the continuous waveform for activation of the second wireless device, and send, via a second set of frequency resources, a backscattered signal of the continuous wave based on modulating the continuous wave with data, where the second set of frequency resources is shifted in frequency relative to the first set of frequency resources.

Another apparatus for wireless communication at a second wireless device is described. The apparatus may include means for receiving a continuous wave via a first set of frequency resources and in accordance with a set of transmission parameters, where the continuous wave includes a continuous waveform for activation of the second wireless device, means for modulating the continuous wave with data based on the continuous waveform for activation of the second wireless device, and means for sending, via a second set of frequency resources, a backscattered signal of the continuous wave based on modulating the continuous wave with data, where the second set of frequency resources is shifted in frequency relative to the first set of frequency resources.

A non-transitory computer-readable medium storing code for wireless communication at a second wireless device is described. The code may include instructions executable by a processor to receive a continuous wave via a first set of frequency resources and in accordance with a set of transmission parameters, where the continuous wave includes a continuous waveform for activation of the second wireless device, modulate the continuous wave with data based on the continuous waveform for activation of the second wireless device, and send, via a second set of frequency resources, a backscattered signal of the continuous wave based on modulating the continuous wave with data, where the second set of frequency resources is shifted in frequency relative to the first set of frequency resources.

Some examples of the method, apparatuses, and non-transitory computer-readable medium described herein may further include operations, features, means, or instructions for sending a message indicating a capability to perform frequency shifting, where sending the backscattered signal via the second set of frequency resources shifted in frequency relative to the first set of frequency resources may be based on the capability to perform the frequency shifting.

In some examples of the method, apparatuses, and non-transitory computer-readable medium described herein, the continuous wave may be received from a first wireless device and the backscattered signal may be sent to a third wireless device.

In some examples of the method, apparatuses, and non-transitory computer-readable medium described herein, the second set of frequency resources may be shifted in frequency relative to the first set of frequency resources based on a frequency shift value.

In some examples of the method, apparatuses, and non-transitory computer-readable medium described herein, a quantity of RBs in the first set of frequency resources may be based on the set of transmission parameters and the set of transmission parameters include a target transmission power, a target reception power, a PSD constraint, or a combination thereof.

In some examples of the method, apparatuses, and non-transitory computer-readable medium described herein, a quantity of RBs in the first set of frequency resources may be based on a classification of the second wireless device.

In some examples of the method, apparatuses, and non-transitory computer-readable medium described herein, the classification of the second wireless device includes one of a passive classification, a semi-passive classification, a semi-active classification, or an active classification.

In some examples of the method, apparatuses, and non-transitory computer-readable medium described herein, the first set of frequency resources may be contiguous in frequency and the second set of frequency resources may be shifted in frequency relative to the first set of frequency resources by a frequency shift value that may be greater than a quantity of RBs of the first set of frequency resources.

In some examples of the method, apparatuses, and non-transitory computer-readable medium described herein, the first set of frequency resources may be non-contiguous in frequency and the second set of frequency resources may be shifted in frequency relative to the first set of frequency resources by a frequency shift value that may be less than a spacing between RBs of the first set of frequency resources.

### BRIEF DESCRIPTION OF THE DRAWINGS

FIG. 1 illustrates an example of a wireless communications system that supports frequency shifting in low power devices in accordance with one or more aspects of the present disclosure.

FIG. 2 illustrates an example of a wireless communications system that supports frequency shifting in low power devices in accordance with one or more aspects of the present disclosure.

FIG. 3 and FIG. 4 illustrate examples of resource allocation diagrams that support frequency shifting in low power devices in accordance with one or more aspects of the present disclosure.

FIG. 5 illustrates an example of a process flow that supports frequency shifting in low power devices in accordance with one or more aspects of the present disclosure.

FIGS. 6 and 7 illustrate block diagrams of devices that support frequency shifting in low power devices in accordance with one or more aspects of the present disclosure.

FIG. 8 illustrates a block diagram of a communications manager that supports frequency shifting in low power devices in accordance with one or more aspects of the present disclosure.

FIG. 9 illustrates a diagram of a system including a device that supports frequency shifting in low power devices in accordance with one or more aspects of the present disclosure.

FIGS. 10 through 13 illustrate flowcharts showing methods that support frequency shifting in low power devices in accordance with one or more aspects of the present disclosure.

### DETAILED DESCRIPTION

In some wireless communications systems, a wireless device (e.g., such as a user equipment (UE) or a network entity) may communicate with one or more low power devices (e.g., such as one or more radio frequency identification (RFID) tags, which may also be referred to as UEs). To facilitate such communications, the wireless device may transmit a continuous wave (e.g., a forward link signal) to the RFID tag, where the RFID tag may use the continuous wave to power or activate the RFID tag and send a backscattered signal to the wireless device. However, in some cases, power spectral density (PSD) constraints of a single band (e.g., carrier, subcarrier, frequency range) may limit the total transmission power of the continuous wave, resulting in limited communication coverage areas. For example, the wireless device may transmit the continuous wave in accordance with the PSD constraints to the RFID tag. However, due to one or more conditions (e.g., distance between the wireless device and RFID tag, obstructions, or the like), the power of the continuous wave may not be sufficient to enable activate the device, enable the backscattered communications, or both. As such, the area in which the wireless device and RFID tag may communicate may be limited, resulting in inefficient communications.

The techniques described herein may enable the wireless device to use an increased quantity of resource blocks (RBs) (e.g., subcarriers, frequency resources) for communications with the RFID tag. For example, the wireless device may transmit the continuous wave using varying quantities of RBs in order to meet target transmission and reception powers of the RFID tag and still be within PSD constraints. In order to avoid interference caused by using an increased quantity of RBs, the RFID tag may perform a frequency shift on the backscattered signal, such that the frequency resources used in transmission of the continuous wave may differ (e.g., by a frequency shift such that the frequency resources do not overlap or partially overlap or be modulated in accordance with frequency-shift keying (FSK)) with the frequency resources used in transmission of the backscattered signal. In some examples, the RFID tag may transmit capability information indicating the capability to perform the frequency shift and indicate a frequency shift value or a range of frequency shift values such as a minimal frequency shift value, a maximum frequency shift value, or a discrete quantity of frequency shift values to the wireless device. In this way, communications between the RFID and wireless device may have a larger communication area, while also accounting for interference.

Aspects of the disclosure are initially described in the context of wireless communications systems. Aspects of the disclosure are further described in the context of resource allocation diagrams and process flows. Aspects of the disclosure are further illustrated by and described with reference to apparatus diagrams, system diagrams, and flowcharts that relate to frequency shifting in low power devices.

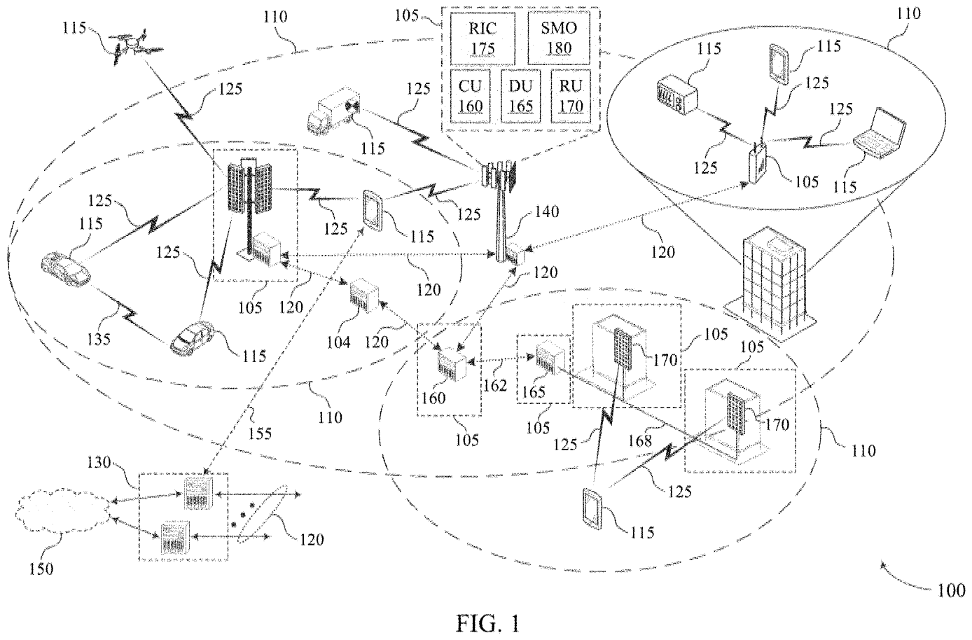

FIG. 1 illustrates an example of a wireless communications system 100 that supports frequency shifting in low power devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1(L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support frequency shifting in low power devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element (RE) may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

In some cases, the UE 115 or the network entity 105 may communicate with one or more passive internet of things (IOT) devices (e.g., such as RFID tags, with varying classifications). For example, passive IoT devices may rely on passive communication technologies, such as backscatter communication. With such technologies, low power and low cost of devices may be achieved. Using current techniques, ultra-high frequency RFID (UHF RFID) systems may be established and widely used. Such systems may also be based on backscatter communication. However, current UHF RFID systems may not be compatible to NR systems. For example, current RFID systems may operate in an ISM band, while NR systems may operate in a licensed band. As such, there may not be techniques to handle interference between those two different systems (e.g., interference handling between ISM bands and NR licensed bands) and a new design of passive IoT in NR may be used.

Further, in an unlicensed band (e.g., NR unlicensed band (NR-U)) the PSD limitation may be equivalent to 8 dBm per 3 kHz (e.g., up to 8 dBm of power per 3 kHz band). Such PSD limitations may limit the total transmission power of the radio frequency source (e.g., source of the continuous wave), which may result in a limited coverage area. For example, in RFID communications, the RFID reader (e.g., or RFID source if different from reader) may use a single tone (e.g., single subband or single RB) to transmit the continuous wave (e.g., forward link). As such, the RFID tag may use the power received from the single tone to send the backscattered link. However, in an unlicensed band, one or more governing bodies (e.g., such as the FCC) may implement regulations regarding PSD per 3 kHz subbands. As such, in zero power IoT (ZP-IOT) in NR-U, if the RFID source uses a single subcarrier (e.g., a single RB), then total transmission power of the RFID source may be limited, thereby limiting the coverage area of RFID communications in NR-U. Further, PSD constraints associated with licensed NR domains may limit the transmission power of the RFID source, thereby limiting the coverage in licensed NR domains (e.g., licensed NR subbands).

The techniques described herein may enable a wireless device (e.g., such as the UE 115 or network entity 105) to use a single subcarrier or multiple subcarriers (e.g., multiple tones, multiple RBs, multiple REs or the like) in order to increase the transmission power of the continuous wave, thereby increasing the coverage area of such communications. Further, the wireless device may determine a quantity of RBs used for a reader to RFID tag communication link based on a classification of the RFID tag. That is, the wireless device may use the influence of RFID tag type, when considering resources allocated for reader to RFID tag communications. Further, introducing multiple subcarriers for such communications may lead to interference cancelling (e.g., which may be difficult to implement). As such, the RFID tag may perform a frequency shift in accordance with a frequency shift value such that the frequency resources of the continuous wave do not interfere with those of the backscattered signal.

For example, the wireless device may transmit the continuous wave via varying quantities of RBs in order to meet target transmission and reception powers of the RFID tag and still be within PSD constraints. In order to avoid interference caused by using an increased quantity of RBs, the RFID tag may perform a frequency shift on the backscattered signal, such that the frequency resources used in transmission of the continuous wave may differ (e.g., do not overlap or partially overlap) with the frequency resources used in transmission of the backscattered signal. In some examples, the RFID tag may transmit capability information indicating the capability to perform the frequency shift and indicate a frequency shift value to the wireless device. In this way, communications between the RFID and wireless device may have a larger communication area, while also accounting for interference.

In some other examples, the wireless device may be enabled to use a single subcarrier (e.g., single tone, single RB, or single RE) with increased power in scenarios where there may not be PSD limitations. In this way, the wireless device may transmit the continuous wave at a power that meets the target transmission power, target reception power, or both of the RFID tag.

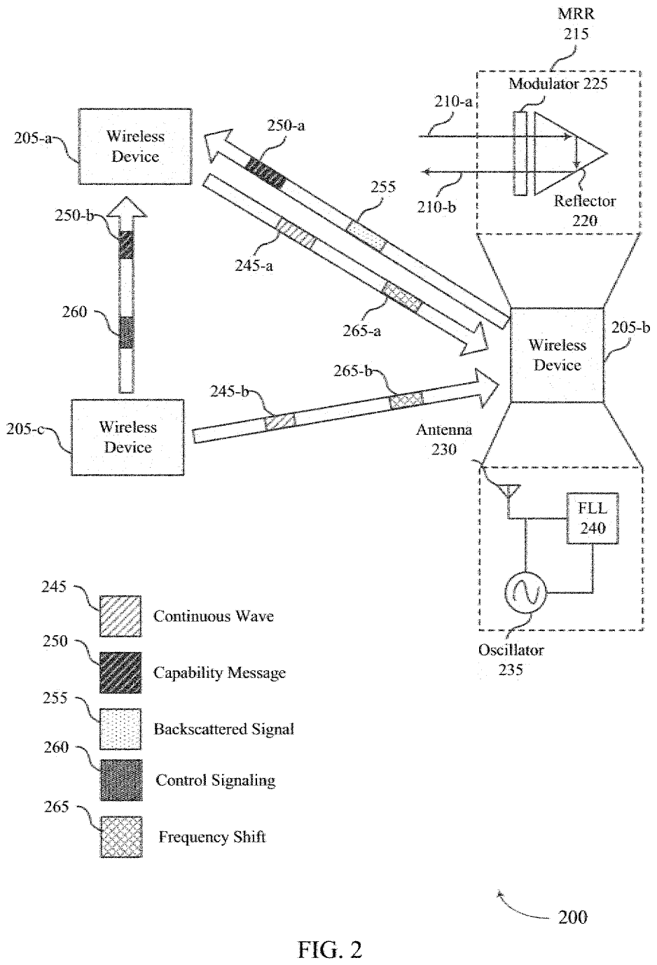

FIG. 2 illustrates an example of a wireless communications system 200 that supports frequency shifting in low power devices in accordance with one or more aspects of the present disclosure. In some examples, the wireless communications system 200 may support aspects of a wireless communications system 100. For example, the wireless communications system 200 may include a wireless device 205-a and wireless device 205-c which may be examples of a UE 115 or a network entity 105 with reference to FIG. 2. Further, the wireless communications system 200 may include a wireless device 205-b, which may be an example of a UE 115 with reference to FIG. 1.

In some examples, the wireless device 205-b may be an example of an RFID tag which may communicate with the wireless device 205-a, the wireless device 205-c, or both via a continuous wave 245 (e.g., forward link) and a backscattered signal 255 (e.g., backward link). As such, the wireless device 205-b may be one or more types of an RFID tag. Systems that support communications between the wireless device 205-a, the wireless device 205-b, and the wireless device 205-c may be referred to as RFID systems and may operate in ISM bands, NR licensed bands, or NR-U bands.

In some examples, the wireless device 205-b may be a passive tag which may be a light weight IoT device with no battery. As such, the passive tag may capture power from a radio wave (e.g., such as the continuous wave 245) and use radio frequency backscatter communications to communicate with the wireless device 205-a. For example, the wireless device 205-b may include a modulated retro reflector (MRR) 215, which may allow the wireless device 205-b to reflect and modulate received optical beams 210 (e.g., at a high bandwidth). The MRR 215 may include a modulator 225 and a reflector 220. There may be many different types of modulators 225 such as deformable micro-electro-mechanical systems (MEMs), liquid crystals, electro-optic phase modulators, and multiple quantum wells (MQW). Further, there may be many different types of reflectors 220 such as corner cube or cat's eye. The wireless device 205-b may receive an optical beam 210 from the wireless device 205-a and change the direction of the optical beam 210 using the reflector 220 (e.g., reflect the optical beam 210 in a same or similar direction in which it was received). The reflected optical beam 210 (e.g., an optical beam 210-a) may pass through the modulator 225 and the modulated optical beam 210 (e.g., the modulated optical beam 210-b) may continue in the direction dictated by the reflector 220. In such examples, the modulated optical beam 210 may be an example of a backscattered signal 255.

In some examples, the wireless device 205-b may be a semi-passive tag, which may be a light weight IoT device that uses radio frequency backscatter communications to communicate with the wireless device 205-a. In some cases, the semi-passive tag may include a battery that may be rechargeable. Additionally, or alternately, the semi-passive tag may perform energy harvesting (e.g., harvest energy from received wireless transmissions, harvest energy from wind power, harvest energy from solar power, or the like) and store the harvested energy in energy storage circuits. Additionally, or alternatively, the semi-passive tag may include a power amplifier that may be embedded in a reception component of the tag or a transmission component of the tag.

In some examples, the wireless device 205-b may be a semi-active tag, which may be light weight IoT device, that uses radio frequency backscatter communications to communicate with the wireless device 205-a. Additionally, or alternatively, the semi-active tag may perform active communications. For example, the wireless device 205-b may receive wireless transmissions at an antenna 230 and transmit a response to the wireless transmissions using the antenna 230. As such, the semi-active tag may include a battery that may be rechargeable or may perform energy harvesting and store the harvested energy in energy storage circuits.

In some examples, the wireless device 205-b may be an active tag which may be a light weight IoT device, that uses active communications to communicate with the wireless device 205-a. As such, the active tag may include a battery that may be rechargeable or may perform energy harvesting and store the harvested energy in energy storage circuits.

As illustrated in FIG. 2, the wireless device 205-b may include an oscillator 235 which may be used to generate transmissions (e.g., backscattering, or active transmissions) from the wireless device 205-b to the wireless device 205-a. For instance, the oscillator 235 may be tuned, such that the transmissions are generated in a given frequency range. In some examples, the wireless device 205-b may include a frequency lock loop (FLL) 240. The FLL 240 may be a circuit that compares the frequency of the oscillator 235 to a reference frequency and may automatically raise or lower the frequency of the oscillator 235 until the frequency of the oscillator 235 matches that of the reference frequency.

In some cases, the wireless device 205-a may communicate with the wireless device 205-b via a single RB (e.g., a single subband). For example, the wireless device 205-a may transmit a continuous wave 245-a (e.g., forward link signal) using the single RB to the wireless device 205-b. Based on receiving the continuous wave 245-a, the wireless device 205-b may use (e.g., in the case of passive or semi-passive RFID tags) or harvest (e.g., in the case of semi-active or active RFID tags) the energy from the continuous wave 245-a in order to modulate the continuous wave 245-a with data and send the backscattered signal 255 (e.g., modulated continuous wave 245-a) to the wireless device 205-a via the single RB. That is, the wireless device 205-a may transmit the continuous wave 245-a continuously, such that the wireless device 205-b may use or harvest the power associated with the continuous wave 245-a in order to transmit the backscattered signal 255. However, PSD constraints associated with single RBs (e.g., single subbands or REs) may limit the transmission power of the continuous wave 245-a, thereby limiting the communication coverage area between the wireless device 205-a and the wireless device 205-b and resulting in less efficient communications.

As described herein, the wireless device 205-a may use varying quantities of RBs (e.g., multiple subcarriers) for transmission of the continuous wave 245-a (e.g., to use in the forward link from reader to RFID tag). That is, the wireless device 205-a may use a different quantity of RBs for transmission of the continuous wave 245-a in order to meet the target transmission and reception powers of the wireless device 205-b while conforming to PSD constraints of each RB (e.g., PSD constraints of each subcarrier).

That is, the wireless device 205-a may transmit the continuous wave 245-a using a quantity of RBs, where the quantity of RBs are configured in order to meet the transmission or reception power constraints of the wireless device 205-b. Alternatively, the wireless device 205-a may be enabled to use a single subcarrier (e.g., single tone, single RB, or single RE) with an increased power (e.g., increased power beyond PSD limitations) in scenarios where there may not be PSD limitations for a single RB. In this way, the wireless device 205-a may transmit the continuous wave 245-a at a power that meets the target transmission power, target reception power, or both of the wireless device 205-b.

In some examples, the wireless device 205-a may use varying quantities of RBs for the transmission of the continuous wave 245-a based on the classification type (e.g., tag type) of the wireless device 205-b. For example, different types of RFID tags (e.g., classifications of the wireless device 205-b) may have different reception sensitivities (e.g., reception powers to activate and use the RFID tag). As such, the wireless device 205-a (e.g., radio frequency source of the wireless device 205-b) may transmit the continuous wave 245-a at different transmission powers in order to meet the power constraints of the varying types of classifications of the wireless device 205-b. In this way, the target transmission power and target reception power may be configured according to the classification type of the wireless device 205-b.

As an illustrative example, if the wireless device 205-b is classified as a passive RFID tag, then the wireless device 205-a may use a first quantity of RBs for transmission of the continuous wave 245-a in order to meet a target reception power of −20 dBm. In another example, if the wireless device 205-b is classified as a semi-passive RFID tag, then the wireless device 205-a may use a second quantity of RBs for transmission of the continuous wave 245-a in order to meet a target reception power of −35 dBm. Further, if the wireless device 205-b is classified as a semi-passive tag with a power amplifier, then the wireless device 205-a may use a third quantity of RBs for transmission of the continuous wave 245-a in order to meet a target reception power of 55 dBm. As such, if distance between the wireless device 205-a and the wireless device 205-b is the same, then the wireless device 205-a may control the transmission power of the continuous wave 245-a by allocating (e.g., controlling) varying quantities of RBs in accordance with the classification of the wireless device 205-b, thereby realizing power savings at the wireless device 205-a.

In some examples, in order to meet the target powers associated with each classification type, the wireless device 205-a may be configured with tables or formulations (e.g., passive RFID tag=x power or x RBs, semi-passive tag=y RBs or y power), such that the wireless device 205-a may look-up or calculate the transmission power. For example, the wireless device 205-a may be pre-configured with a table that indicates a power, a quantity of RBs, or both associated with each classification type (e.g., passive, semi-passive, semi-active, active). Additionally, or alternatively, the wireless device 205-a may use one or more formulations to calculate the target power, quantity of RBs, or both based on the classification of the wireless device 205-b.

In some examples, the wireless device 205-c (e.g., a network entity or a sidelink UE) may transmit control signaling 260 indicating for the wireless device 205-a (e.g., UE) to communicate with the wireless device 205-b. As such, if wireless device 205-c indicates to the wireless device 205-a to communicate with the wireless device 205-b, then the wireless device 205-c may indicate, via control signaling 260, the target transmission and reception powers, a quantity of RBs, the classification type of the wireless device 205-b, a quantity of RBs per classification type relationship, or a combination thereof, dynamically to wireless device 205-a. Further, the wireless device 205-c may configure the wireless device 205-a with tables (e.g., tables indicating the target transmission power, quantity of RBs, or both per classification type). In such cases, the wireless device 205-a may dynamically determine the transmission power (e.g., the quantity of RBs) for the continuous wave 245-a based on the configured tables. Alternatively, the wireless device 205-a may be preconfigured with the transmission power per RFID tag classification.

Based on determining the quantity of RBs (e.g., transmission power), the wireless device 205-a may transmit the continuous wave 245-a using a first set of frequency resources that includes the determined quantity of RBs. The wireless device 205-b may receive the continuous wave 245-a, modulate the continuous wave 245-a with data to generate the backscattered signal 255, and send the backscattered signal 255 to the wireless device 205-a using energy or power obtained or harvested (e.g., via energy harvesting) from the continuous wave 245-a. That is, the wireless device may send the backscattered signal 255 via the first set of resources using the quantity of RBs used for the continuous wave 245-a.

However, if the wireless device 205-b uses the same RBs (e.g., same subcarriers) for the backscattered signal 255 that were used for the continuous wave 245-a, then, at the wireless device 205-a, the backscattered signal 255 may interfere with (e.g., drown out) the continuous wave 245-a. That is, in order to enable the wireless device 205-b to send the backscattered signal 255, the wireless device 205-a may continuously transmit the continuous wave 245-a (e.g., an unmodulated wave in the forward link) in order to provide a carrier wave for the backscattered signal 255 (e.g., backscattered link). However, if the backscattered signal 255 is sent using the same RBs as the continuous wave 245-a, then the wireless device 205-a may experience interference, which may result in the wireless device 205-a not successfully receiving the backscattered signal 255.

As described herein, the wireless device 205-b may be configured to perform a frequency shift in order to realize some frequency division multiplexing (FDM) for the backscattered signal 255 and the continuous wave 245-a. As such, the wireless device 205-a may filter out the RBs associated with the continuous wave 245-a (e.g., the unmodulated reference signal tones) and receive the backscattered signal 255. That is, the wireless device 205-b may receive the continuous wave 245-a via the first set of frequency resources (e.g., that include the determined quantity of RBs to satisfy the target transmission and reception power) and send the backscattered signal 255 via a second set of frequency resources (e.g., that include the same quantity of RBs as the first set of frequency resources) that are shifted relative to the first set of frequency resources).

For example, in order to avoid overlapping in frequency (e.g., overlapping between the RBs used for the continuous wave 245-a and the backscattered signal 255), the wireless device 205-b may perform frequency shifting on the RBs used for the backscattered signal. The wireless device 205-b may shift the backscattered signal in frequency relative to the continuous wave 245-a based on a frequency shift value. Such frequency shift value may be provided in units of RBs, REs, or frequency units. Further, the capability to perform frequency shifting may be associated with the classification type of the wireless device 205-b. As an illustrative example, if the wireless device 205-b is classified as passive, then the wireless device 205-b may not perform frequency shifting (e.g., not have the ability to perform frequency shifting). In another example, if the wireless device 205-b is classified as semi-passive, then the wireless device 205-a may perform frequency shifting (e.g., have the ability to perform frequency shifting).

In some examples, the frequency shift value may be preconfigured at the wireless device 205-a based on the classification of the wireless device 205-b. That is, the wireless device 205-a may be preconfigured with one or more tables indicating the frequency shift capability and the frequency shift value associated with each classification type. In some other examples, the wireless device 205-b may transmit a capability message 250-a to the wireless device 205-a, where the capability message 250-a may indicate the capability of the of the wireless device 205-b to perform frequency shifting, the classification of the wireless device 205-b, the frequency shift value, or a combination thereof. In some examples, the wireless device 205-a (e.g., acting as both the radio frequency source and reader in full-duplex mode) may dynamically configure the frequency shift value of the wireless device 205-b. That is, the wireless device 205-a may transmit a frequency shift message 265-a indicating the frequency shift value to the wireless device 205-b.

In some examples, the wireless device 205-c may be the radio frequency source (e.g., transmitter of the continuous wave 245-b), while the wireless device 205-a may be the reader (e.g., receiver of the backscattered signal 255). In such examples, the wireless device 205-c may dynamically configure the frequency shift value to the wireless device 205-b. That is, the wireless device 205-c may transmit a frequency shift message 265-b to the wireless device 205-b indicating the frequency shift value. As such, the wireless device 205-c may transmit a capability message 250-b to the wireless device 205-a indicating the capability of the wireless device 205-b to perform frequency shifting, a classification of the wireless device 205-b, the frequency shift value, or a combination thereof.

In some examples, the wireless device 205-c may indicate to the wireless device 205-a to communicate with the wireless device 205-b. In such examples, the wireless device 205-c may transmit the capability message 250-b indicating the frequency shift value to be used in communications with the wireless device 205-b.

Further, the capability message 250-b may include the allocation of RBs used for transmission of the continuous wave 245-b and the allocation of RBs used after the wireless device 205-b performs backscattering (e.g., the shifted RBs used to send the backscattered signal 255).

That is, the wireless device 205-c (e.g., the radio frequency source) may signal the continuous wave 245-b (e.g., unmodulated continuous waveform) to the wireless device 205-a (e.g., the reader). As such, the wireless device 205-a may use the information received in the capability message 250-b and the signaled allocation of the continuous wave 245-b to determine the allocation of the backscattered signal. For example, the wireless device 205-a may use the classification of the wireless device 205-b (e.g., given RFID tag class), the capability of the wireless device 205-b to perform frequency shifting, the frequency shift value (e.g., the frequency shift configuration), or a combination thereof, to determine the allocation of the backscattered signal 255. The wireless device 205-c may transmit the continuous wave 245-b to the wireless device 205-b via a first frequency resource set, where the wireless device 205-b may use or harvest the power from the continuous wave 245-b to modulate the continuous wave 245-b with data, generate the backscattered signal 255, and send the backscattered signal 255 in accordance with the frequency shift value. The wireless device 205-a may monitor a quantity of RBs for the backscattered signal based on the information indicated in the capability message 250-b. That is, the wireless device 205-a may monitor a second frequency resource set that has been shifted relative to the first frequency resource set by the frequency shift value. Based on monitoring, the wireless device 205-a may receive the backscattered signal 255 via the second frequency resource set.

In some examples, the wireless device 205-a (e.g., the reader) may use the continuous wave 245 (e.g., a signaled unmodulated forward link signal) to estimate the channel between the wireless device 205-a and the wireless device 205-b. In such examples, the wireless device 205-a may perform time and frequency corrections based on the channel estimations in order to decode the backscattered signal 255.

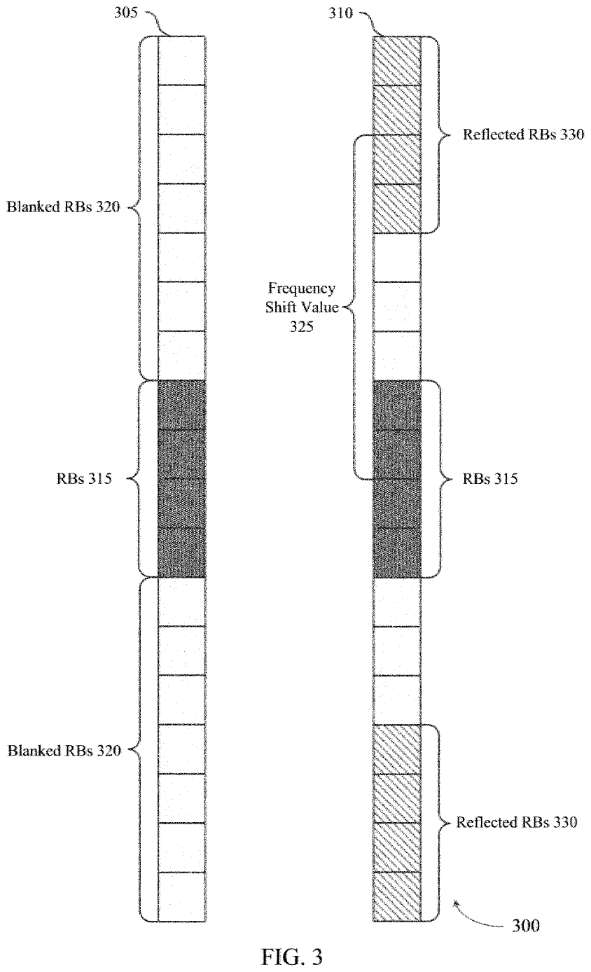

FIG. 3 illustrates an example of a resource allocation diagram 300 that supports frequency shifting in low power devices in accordance with one or more aspects of the present disclosure. The resource allocation diagram 300 may implement, or be implemented by, aspects of the wireless communications system 100 and the wireless communications system 200. For example, the resource allocation diagram may be implemented by a UE 115, a RFID tag, a network entity 105 as described herein with reference to FIGS. 1 and 2. The resource allocation diagram 300 may include frequency resources 305 and frequency resources 310, which may be an example of a first set of frequency resources and a second set of frequency resources as described herein with reference to FIG. 2. As described herein, the term RB may refer to any one of a frequency tone, subcarrier, subband, RE, a frequency unit, or the like.

In some examples, the frequency resources 305 may be used in communications between an RFID source, RFID reader, and a RFID tag (e.g., the RFID source and RFID reader may be the same device or different devices). For example, the frequency resources 305 may include one or more RBs 315 allocated for the transmission of a continuous wave (e.g., such as a continuous wave 245 as described herein). That is, the RFID source may use varying quantities of RBs 315 in order to transmit the continuous wave and meet the target transmission and reception powers of an RFID tag. The RFID source may determine the quantity of RBs 315 in accordance with the techniques described herein with reference to FIG. 2. Further, the frequency resources may contain one or more blanked RBs 320. Such blanked RBs 320 may be allocated for use by other devices in a wireless communications system.

The RFID tag may receive the continuous wave and use or harvest the power from the continuous wave in order to modulate the continuous wave with data and generate a backscattered signal (e.g., such as a backscattered signal 255 as described herein). In accordance with the techniques described herein, the RFID tag may shift the resources 310 in frequency relative to the frequency resources 305 by a frequency shift value 325 in order to avoid frequency overlap between the reflected RBs 330 (which may refer to the RBs used for the backscattered signal and in some cases may be referred to as backscattered RBs) and the RBs 315 (used for the continuous wave).

In some examples, the size of the frequency shift value 325 may be based on the structure of the RBs 315 in the resources 305. For example, if the RBs 315 used for the continuous wave (e.g., forward link subcarriers) are contiguous in the frequency resources 305, then the frequency shift value 325 may be at least larger than the quantity of RBs 315 used for the continuous wave (e.g., unmodulated signal used by RF source). As such, in the case the RFID reader is different from the RFID source, the RFID reader may receive an indication of the allocated RBs 315 used for the continuous wave and the frequency shift value 325 in order to determine the frequency allocation of the backscattered signal in the frequency resources 310. If the RFID reader and the RFID source are the same device, then the RFID reader may monitor the reflected RBs 330 in accordance with the frequency shift value 325 known at the RFID reader.

For example, the RFID source may allocate and transmit the RBs 315 continuously in the frequency resources 305. As such, the RFID tag may shift the reflected RBs 330 by a frequency shift value 325 that is greater than the quantity of RBs 315. As illustrated in the resource allocation diagram 300, the RFID source may allocate four contiguous RBs 315 in the frequency resources 305 to be used for transmission of the continuous wave. As such, the frequency shift value 325 at the RFID tag may be at least greater than four. As illustrated, the frequency shift value 325 may be seven. In this way, the RFID tag may send the backscattered signal via reflected RBs 330 that have been shifted in frequency relative to the RBs 315 used for the transmission of the continuous wave, thereby avoiding interference between the two signals.

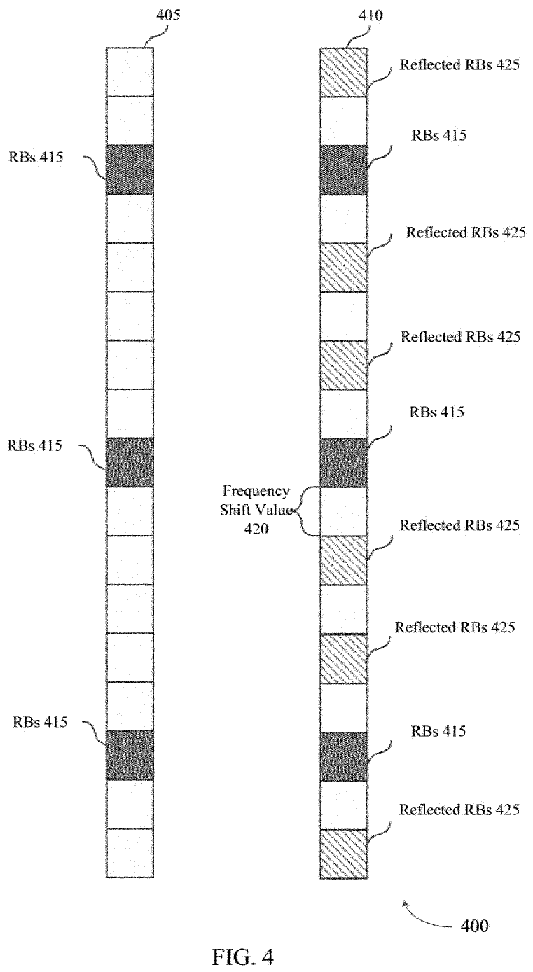

FIG. 4 illustrates an example of a resource allocation diagram 400 that supports frequency shifting in low power devices in accordance with one or more aspects of the present disclosure. Aspects of the resource allocation diagram 400 may implement, or be implemented by, aspects of the wireless communications system 100, the wireless communications system 200, and the resource allocation diagram 300 as described herein. For example, the resource allocation diagram may be implemented by a UE 115, a network entity 105, and a RFID tag. Further, the resource allocation diagram 400 may include frequency resources 405 and frequency resources 410, which may be an example of a first set of frequency resources and a second set of frequency resources as described herein with reference to FIGS. 2 and 3.

In some examples, the frequency resources 405 may be used in communications between an RFID source, RFID reader, and a RFID tag (e.g., the RFID source and RFID reader may be the same device or different devices). For example, the frequency resources 405 may include one or more RBs 415 allocated for the transmission of a continuous wave (e.g., such as a continuous wave 245 as described herein). That is, the RFID source may use varying quantities of RBs 415 in order to transmit the continuous wave and meet the target transmission and reception powers of an RFID tag. The RFID source may determine the quantity of RBs 415 in accordance with the techniques described herein with reference to FIG. 2.

The RFID tag may receive the continuous wave and use or harvest the power from the continuous wave in order to modulate the continuous wave with data and generate a backscattered signal (e.g., such as a backscattered signal 255 as described herein). In accordance with the techniques described herein, the RFID tag may shift the resources 410 in frequency relative to the frequency resources 405 by a frequency shift value 420 in order to avoid frequency overlap between the reflected RBs 425 (used for the backscattered signal) and the RBs 415 (used for the continuous wave).

In some examples, the size of the frequency shift value 420 may be based on the structure of the RBs 415 in the resources 405. For example, the RBs 415 may be allocated in a comb-like structure in the frequency resources 405. That is, if the RBs 415 in the frequency resources 405 are discretely allocated and transmitted with a spacing or comb level (e.g., similar to sounding reference signals), then the frequency shift value 420 may be smaller than the spacing in the frequency resources 405. In general, the granularity of the frequency shift value 420 may be given in terms of RBs.

For example, the RBs 415 may be allocated in a comb-like structure in the resources 405. As such, the frequency shift value 420 that is used by the RFID tag may be less than the spacing between RBs 415. As an illustrative example, the RFID source may allocate the RBs 415 in increments of five RBs. As such, the frequency shift value 420 may be configured to be less than five. As illustrated, the frequency shift value 420 used in the frequency resources 410 may be equal to one. In this way, the RFID tag may send the backscattered signal via reflected RBs 425 that have been shifted in frequency relative to the RBs 415 used for the transmission of the continuous wave, thereby avoiding interference between the two signals.

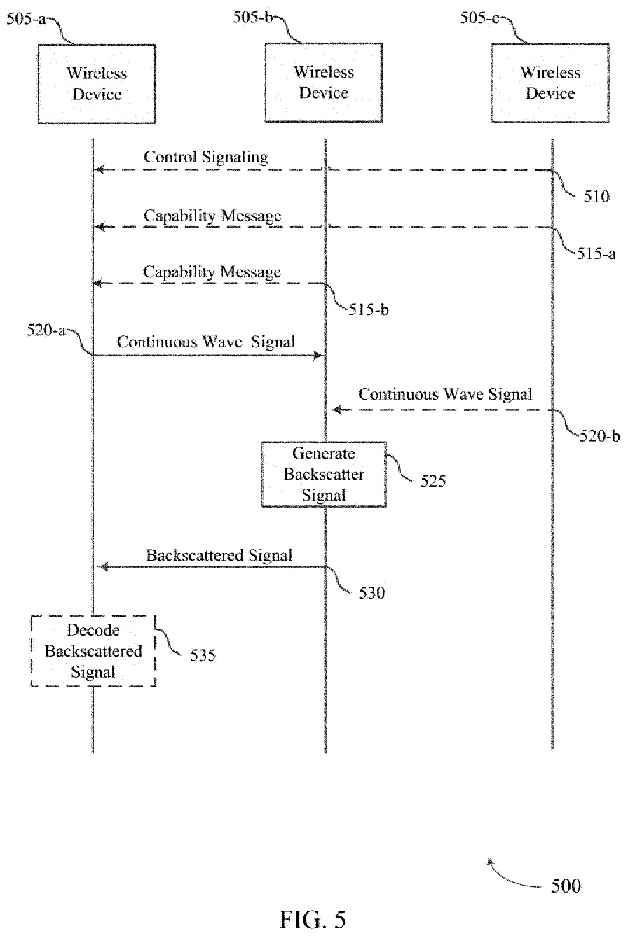

FIG. 5 illustrates an example of a process flow 500 that supports frequency shifting in low power devices in accordance with one or more aspects of the present disclosure. Aspects of the process flow 500 may implement, or be implemented by, aspects the wireless communications system 100, the wireless communications system 200, the resource allocation diagram 300, and the resource allocation diagram 400. For example, the process flow 500 may include a wireless device 505-a, which may be examples of the wireless device 205-a, a UE 115, or a network entity 105 that may operate as both an RFID source and RFID reader as described herein. Further, the process flow 500 may include a wireless device 505-b, which may be an example of the wireless device 205-b or an RFID tag. The process flow 500 may also include a wireless device 505-c, which may be an example of a wireless device 205-c that is an RFID source.

In the following description of the process flow 500, the operations may be performed in a different order than the order shown. Specific operations also may be left out of the process flow 500, or other operations may be added to the process flow 500. Further, although some operations or signaling may be shown to occur at different times for discussion purposes, these operations may actually occur at the same time.

The process flow 500 may illustrate one or more operations that support using various quantities of RBs in order to meet the target transmission and reception powers of low power devices. Further, the process flow 500 may illustrate operations that enable frequency shifting in low power devices. In some other examples, the process flow may illustrate one or more operations that support using a single subcarrier (e.g., single tone, single RB, or single RE) with increased power in scenarios where there may not be PSD limitations in the wireless communications system. In this way, target transmission power, target reception power, or both for low power devices may be met while using a single RB for transmission of the continuous wave.

At 510, the wireless device 505-c may transmit control signaling (e.g., such as a control message) to the wireless device 505-a that includes an indication to communicate with the wireless device 505-b. The control signaling may include a first set of frequency resources for transmission of a continuous wave, a quantity of RBs used in the first set of frequency resources for transmission of the continuous wave, a target transmission power, a target reception power of the wireless device 505-b, a classification (e.g., tag type) of the wireless device 505-b, or a combination thereof. In some examples, the wireless device 505-c may include, in the control signaling, a frequency shift value of a second set of resources to be used by the wireless device 505-b in order to transmit a backscattered signal.

At 515-a, the wireless device 505-c may optionally transmit a message that includes a capability of the wireless device 505-b to perform frequency shifting. In some examples, the wireless device 505-c may include the frequency shift value in the capability message. At 515-b, the wireless device 505-b may optionally transmit a message that includes a capability of the wireless device 505-b to perform frequency shifting. The wireless device 505-b may include, in the capability message, the frequency shift value to be used.

At 520, the wireless device 505-b may receive a continuous wave via the first set of frequency resources in accordance with a set of transmission parameters. In such examples, the continuous wave may include a continuous waveform used for activation of the wireless device 505-b. That is, the continuous wave may be received continuously in order for the wireless device 205-b to generate the backscattered signal. In some examples, at 520-a, the continuous wave may be transmitted from the wireless device 505-a (e.g., the wireless device 505-a is both the RFID source and RFID reader). Alternatively, at 520-b, the continuous wave may be transmitted from the wireless device 505-c (e.g., the wireless device 505-c is the RFID source and the wireless device 505-a is the RFID reader).

In some examples, a quantity of RBs used in the first set of frequency resources may be based on the set of transmission parameters, where the transmission parameters include a target transmission power, a target reception power, a PSD constraint, or a combination thereof. In some other examples, the quantity of RBs used in the first set of frequency resources may be based on the classification of the wireless device 505-b. The classification of the wireless device 505-b may be one of a passive classification, a semi-passive classification, a semi-active classification, or an active classification. Further, the RBs of the first set of frequency resources may be transmitted contiguously (e.g., continuous in the frequency domain) or non-contiguous (e.g., discretely in the frequency domain).

At 525, the wireless device 505-b may modulate the continuous wave with data based on receiving the continuous waveform activating the wireless device 505-b. The wireless device 505-b may send, via the second set of frequency resources, a backscattered signal of the continuous wave. That is, the wireless device 505-b may use or harvest the energy from the continuous waveform in order to modulate the continuous wave with data and send the backscattered signal (e.g., the modulated continuous wave with data) via the second set of resources. In such examples, the second set of resources may be shifted in frequency relative to the first set of frequency resources in accordance with the frequency shift value.

For example, the wireless device 505-b may use the frequency shift value that is based on the structure of the first set of resources. That is, if the wireless device 505-b received the RBs of the first set of frequency resources contiguously (e.g., in the frequency domain), then the wireless device 505-b may use a frequency shift value that is at least larger than the quantity of RBs in the first set of frequency resources.

Alternatively, if the wireless device 505-b received the RBs of the first set of frequency resources in a non-contiguous pattern, then the wireless device 505-b may use a frequency shift value that is smaller than the spacing between the RBs of the first set of frequency resources.

At 530, the wireless device 505-a may receive, from the wireless device 505-b and via the second set of frequency resources, the backscattered signal of the continuous wave, where the second set of frequency resources are shifted in frequency relative to the first set of frequency resources.

At 535, the wireless device 505-a may optionally perform channel estimations on the channel between the wireless device 505-a and the wireless device 505-b based on the continuous wave. In such examples, the wireless device 505-a may perform time and frequency corrections to decode the backscattered signal based on performing the channel estimations.

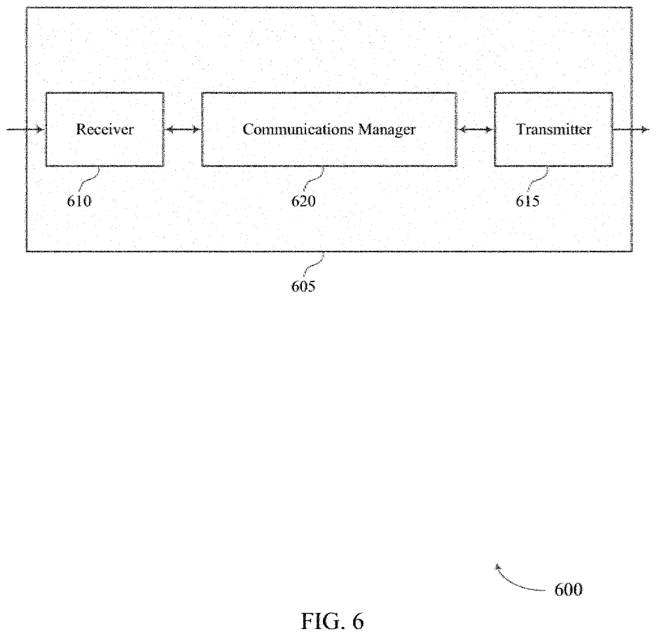

FIG. 6 illustrates a block diagram 600 of a device 605 that supports frequency shifting in low power devices in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to frequency shifting in low power devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to frequency shifting in low power devices). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of frequency shifting in low power devices as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first wireless device in accordance with examples as disclosed herein. For example, the communications manager 620 may be configured as or otherwise support a means for transmitting, to a second wireless device, a continuous wave via a first set of frequency resources and in accordance with a set of transmission parameters, where the continuous wave includes a continuous waveform for activation of the second wireless device. The communications manager 620 may be configured as or otherwise support a means for receiving, from the second wireless device and via a second set of frequency resources, a backscattered signal of the continuous wave, where the second set of frequency resources is shifted in frequency relative to the first set of frequency resources.

Additionally, or alternatively, the communications manager 620 may support wireless communication at a second wireless device in accordance with examples as disclosed herein. For example, the communications manager 620 may be configured as or otherwise support a means for receiving a continuous wave via a first set of frequency resources and in accordance with a set of transmission parameters, where the continuous wave includes a continuous waveform for activation of the second wireless device. The communications manager 620 may be configured as or otherwise support a means for modulating the continuous wave with data based on the continuous waveform for activation of the second wireless device. The communications manager 620 may be configured as or otherwise support a means for sending, via a second set of frequency resources, a backscattered signal of the continuous wave based on modulating the continuous wave with data, where the second set of frequency resources is shifted in frequency relative to the first set of frequency resources.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for receiving a backscattered signal via RBs that have been shifted in frequency, which may result in more efficient utilization of communication resources.

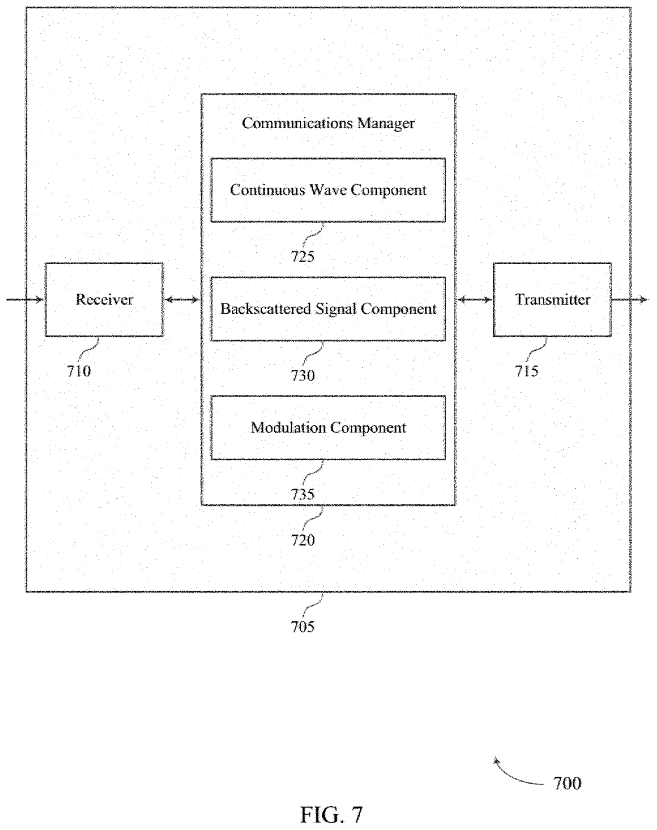

FIG. 7 illustrates a block diagram 700 of a device 705 that supports frequency shifting in low power devices in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to frequency shifting in low power devices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to frequency shifting in low power devices). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of frequency shifting in low power devices as described herein. For example, the communications manager 720 may include a continuous wave component 725, a backscattered signal component 730, a modulation component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first wireless device in accordance with examples as disclosed herein. The continuous wave component 725 may be configured as or otherwise support a means for transmitting, to a second wireless device, a continuous wave via a first set of frequency resources and in accordance with a set of transmission parameters, where the continuous wave includes a continuous waveform for activation of the second wireless device. The backscattered signal component 730 may be configured as or otherwise support a means for receiving, from the second wireless device and via a second set of frequency resources, a backscattered signal of the continuous wave, where the second set of frequency resources is shifted in frequency relative to the first set of frequency resources.

Additionally, or alternatively, the communications manager 720 may support wireless communication at a second wireless device in accordance with examples as disclosed herein. The continuous wave component 725 may be configured as or otherwise support a means for receiving a continuous wave via a first set of frequency resources and in accordance with a set of transmission parameters, where the continuous wave includes a continuous waveform for activation of the second wireless device. The modulation component 735 may be configured as or otherwise support a means for modulating the continuous wave with data based on the continuous waveform for activation of the second wireless device. The backscattered signal component 730 may be configured as or otherwise support a means for sending, via a second set of frequency resources, a backscattered signal of the continuous wave based on modulating the continuous wave with data, where the second set of frequency resources is shifted in frequency relative to the first set of frequency resources.

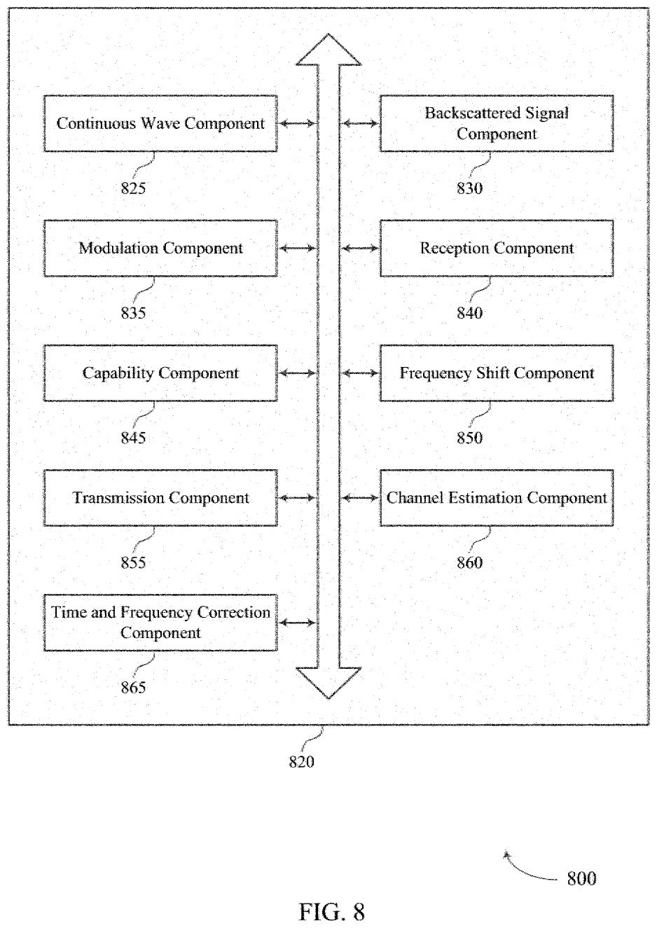

FIG. 8 illustrates a block diagram 800 of a communications manager 820 that supports frequency shifting in low power devices in accordance with one or more aspects of the present disclosure. The communications manager 820 may be an example of aspects of a communications manager 620, a communications manager 720, or both, as described herein. The communications manager 820, or various components thereof, may be an example of means for performing various aspects of frequency shifting in low power devices as described herein. For example, the communications manager 820 may include a continuous wave component 825, a backscattered signal component 830, a modulation component 835, a reception component 840, a capability component 845, a frequency shift component 850, a transmission component 855, a channel estimation component 860, a time and frequency correction component 865, or any combination thereof. Each of these components may communicate, directly or indirectly, with one another (e.g., via one or more buses).

The communications manager 820 may support wireless communication at a first wireless device in accordance with examples as disclosed herein. The continuous wave component 825 may be configured as or otherwise support a means for transmitting, to a second wireless device, a continuous wave via a first set of frequency resources and in accordance with a set of transmission parameters, where the continuous wave includes a continuous waveform for activation of the second wireless device. The backscattered signal component 830 may be configured as or otherwise support a means for receiving, from the second wireless device and via a second set of frequency resources, a backscattered signal of the continuous wave, where the second set of frequency resources is shifted in frequency relative to the first set of frequency resources.

In some examples, the reception component 840 may be configured as or otherwise support a means for receiving, from a network entity, a message including an indication to communicate with the second wireless device, a quantity of RBs to use in the first set of frequency resources, a target transmission power, a target reception power, a classification of the second wireless device, or a combination thereof, where transmitting the continuous wave via the first set of frequency resources is based on the message.

In some examples, the capability component 845 may be configured as or otherwise support a means for receiving a message including a capability of the second wireless device to perform frequency shifting, where receiving the backscattered signal via the second set of frequency resources shifted in frequency relative to the first set of frequency resources is based on the message.

In some examples, the frequency shift component 850 may be configured as or otherwise support a means for receiving a message indicating a frequency shift value of the second set of frequency resources, where the second set of frequency resources are shifted in frequency relative to the first set of frequency resources based on the frequency shift value.

In some examples, the transmission component 855 may be configured as or otherwise support a means for transmitting, to a third wireless device, an indication of the first set of frequency resources used for the continuous wave, a frequency shift value, or both.

In some examples, the channel estimation component 860 may be configured as or otherwise support a means for performing channel estimations on a channel between the first wireless device and the second wireless device based on the continuous wave. In some examples, the time and frequency correction component 865 may be configured as or otherwise support a means for performing time and frequency corrections to decode the backscattered signal based on performing the channel estimations.

In some examples, the first set of frequency resources are contiguous in frequency. In some examples, the second set of frequency resources are shifted in frequency relative to the first set of frequency resources by a frequency shift value that is greater than a quantity of RBs of the first set of frequency resources.

In some examples, the first set of frequency resources are non-contiguous in frequency. In some examples, the second set of frequency resources are shifted in frequency relative to the first set of frequency resources by a frequency shift value that is less than a spacing between RBs of the first set of frequency resources.

In some examples, a quantity of RBs in the first set of frequency resources is based on the set of transmission parameters. In some examples, the set of transmission parameters include a target transmission power, a target reception power, a PSD constraint, or a combination thereof.

In some examples, a quantity of RBs in the first set of frequency resources is based on a classification of the second wireless device.

In some examples, the classification of the second wireless device includes one of a passive classification, a semi-passive classification, a semi-active classification, or an active classification.

In some examples, the second set of frequency resources are shifted in frequency relative to the first set of frequency resources based on a frequency shift value. In some examples, the frequency shift value is preconfigured at the first wireless device.

Additionally, or alternatively, the communications manager 820 may support wireless communication at a second wireless device in accordance with examples as disclosed herein. In some examples, the continuous wave component 825 may be configured as or otherwise support a means for receiving a continuous wave via a first set of frequency resources and in accordance with a set of transmission parameters, where the continuous wave includes a continuous waveform for activation of the second wireless device. The modulation component 835 may be configured as or otherwise support a means for modulating the continuous wave with data based on the continuous waveform for activation of the second wireless device. In some examples, the backscattered signal component 830 may be configured as or otherwise support a means for sending, via a second set of frequency resources, a backscattered signal of the continuous wave based on modulating the continuous wave with data, where the second set of frequency resources is shifted in frequency relative to the first set of frequency resources.

In some examples, the capability component 845 may be configured as or otherwise support a means for sending a message indicating a capability to perform frequency shifting, where sending the backscattered signal via the second set of frequency resources shifted in frequency relative to the first set of frequency resources is based on the capability to perform the frequency shifting.

In some examples, the continuous wave is received from a first wireless device and the backscattered signal is sent to a third wireless device.

In some examples, the second set of frequency resources are shifted in frequency relative to the first set of frequency resources based on a frequency shift value.

In some examples, a quantity of RBs in the first set of frequency resources is based on the set of transmission parameters. In some examples, the set of transmission parameters include a target transmission power, a target reception power, a PSD constraint, or a combination thereof.

In some examples, a quantity of RBs in the first set of frequency resources is based on a classification of the second wireless device.

In some examples, the classification of the second wireless device includes one of a passive classification, a semi-passive classification, a semi-active classification, or an active classification.

In some examples, the first set of frequency resources are contiguous in frequency. In some examples, the second set of frequency resources are shifted in frequency relative to the first set of frequency resources by a frequency shift value that is greater than a quantity of RBs of the first set of frequency resources.

In some examples, the first set of frequency resources are non-contiguous in frequency. In some examples, the second set of frequency resources are shifted in frequency relative to the first set of frequency resources by a frequency shift value that is less than a spacing between RBs of the first set of frequency resources.

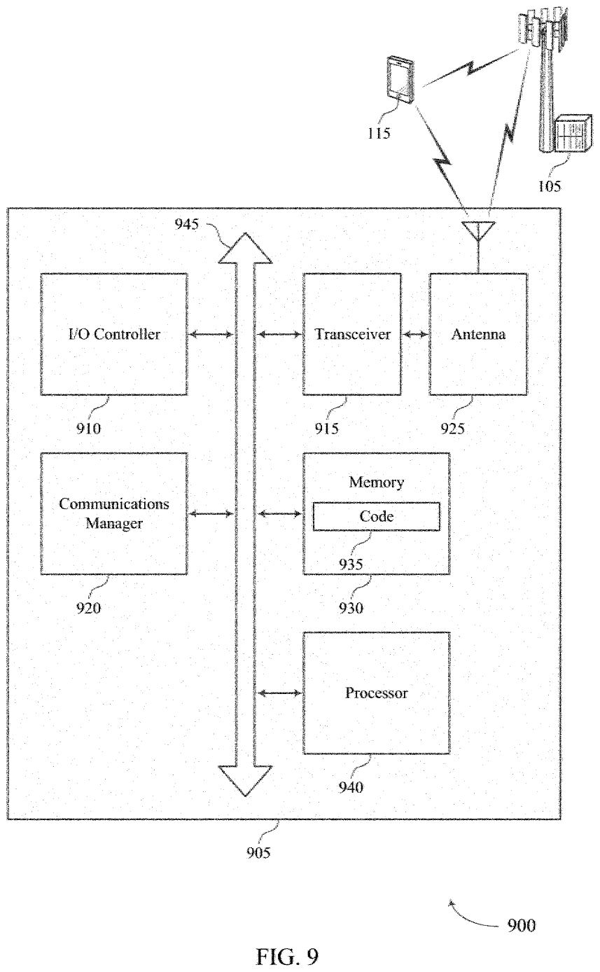

FIG. 9 illustrates a diagram of a system 900 including a device 905 that supports frequency shifting in low power devices in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting frequency shifting in low power devices). For example, the device 905 or a component of the device 905 may include a processor 940 and memory 930 coupled with or to the processor 940, the processor 940 and memory 930 configured to perform various functions described herein.

The communications manager 920 may support wireless communication at a first wireless device in accordance with examples as disclosed herein. For example, the communications manager 920 may be configured as or otherwise support a means for transmitting, to a second wireless device, a continuous wave via a first set of frequency resources and in accordance with a set of transmission parameters, where the continuous wave includes a continuous waveform for activation of the second wireless device. The communications manager 920 may be configured as or otherwise support a means for receiving, from the second wireless device and via a second set of frequency resources, a backscattered signal of the continuous wave, where the second set of frequency resources is shifted in frequency relative to the first set of frequency resources.

Additionally, or alternatively, the communications manager 920 may support wireless communication at a second wireless device in accordance with examples as disclosed herein. For example, the communications manager 920 may be configured as or otherwise support a means for receiving a continuous wave via a first set of frequency resources and in accordance with a set of transmission parameters, where the continuous wave includes a continuous waveform for activation of the second wireless device. The communications manager 920 may be configured as or otherwise support a means for modulating the continuous wave with data based on the continuous waveform for activation of the second wireless device. The communications manager 920 may be configured as or otherwise support a means for sending, via a second set of frequency resources, a backscattered signal of the continuous wave based on modulating the continuous wave with data, where the second set of frequency resources is shifted in frequency relative to the first set of frequency resources.

By including or configuring the communications manager 920 in accordance with examples as described herein, the device 905 may support techniques for receiving a backscattered signal via RBs that have been shifted in frequency, which may result in improved communication reliability, reduced latency and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of frequency shifting in low power devices as described herein, or the processor 940 and the memory 930 may be otherwise configured to perform or support such operations.

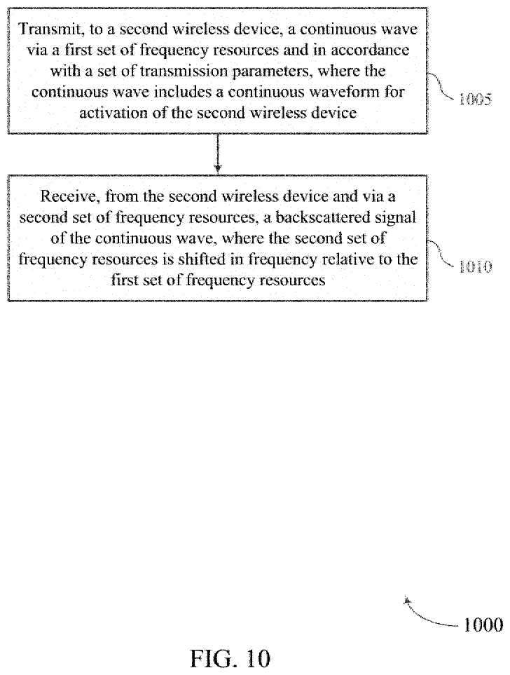

FIG. 10 illustrates a flowchart showing a method 1000 that supports frequency shifting in low power devices in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include transmitting, to a second wireless device, a continuous wave via a first set of frequency resources and in accordance with a set of transmission parameters, where the continuous wave includes a continuous waveform for activation of the second wireless device. The operations of 1005 may be performed in accordance with examples as disclosed herein. In some examples, aspects of the operations of 1005 may be performed by a continuous wave component 825 as described with reference to FIG. 8.

At 1010, the method may include receiving, from the second wireless device and via a second set of frequency resources, a backscattered signal of the continuous wave, where the second set of frequency resources is shifted in frequency relative to the first set of frequency resources. The operations of 1010 may be performed in accordance with examples as disclosed herein. In some examples, aspects of the operations of 1010 may be performed by a backscattered signal component 830 as described with reference to FIG. 8.

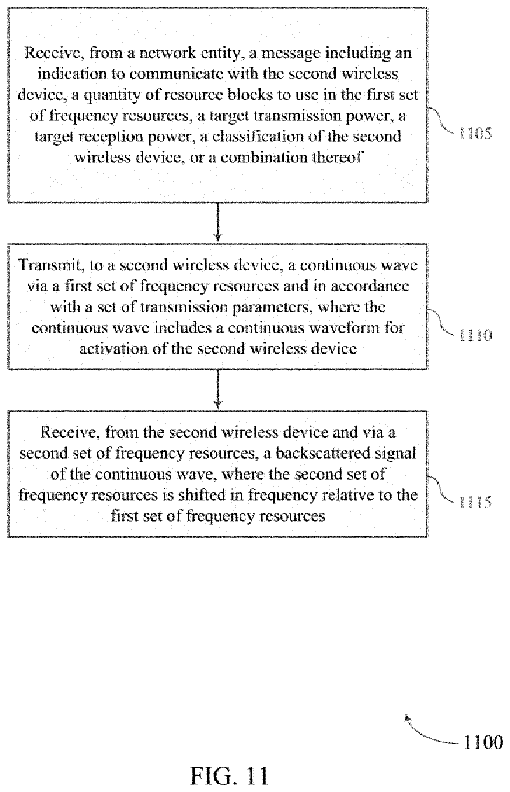

FIG. 11 illustrates a flowchart showing a method 1100 that supports frequency shifting in low power devices in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving, from a network entity, a message including an indication to communicate with the second wireless device, a quantity of RBs to use in the first set of frequency resources, a target transmission power, a target reception power, a classification of the second wireless device, or a combination thereof. The operations of 1105 may be performed in accordance with examples as disclosed herein. In some examples, aspects of the operations of 1105 may be performed by a reception component 840 as described with reference to FIG. 8.

At 1110, the method may include transmitting, to a second wireless device, a continuous wave via a first set of frequency resources and in accordance with a set of transmission parameters, where the continuous wave includes a continuous waveform for activation of the second wireless device. The operations of 1110 may be performed in accordance with examples as disclosed herein. In some examples, aspects of the operations of 1110 may be performed by a continuous wave component 825 as described with reference to FIG. 8.

At 1115, the method may include receiving, from the second wireless device and via a second set of frequency resources, a backscattered signal of the continuous wave, where the second set of frequency resources is shifted in frequency relative to the first set of frequency resources. The operations of 1115 may be performed in accordance with examples as disclosed herein. In some examples, aspects of the operations of 1115 may be performed by a backscattered signal component 830 as described with reference to FIG. 8.

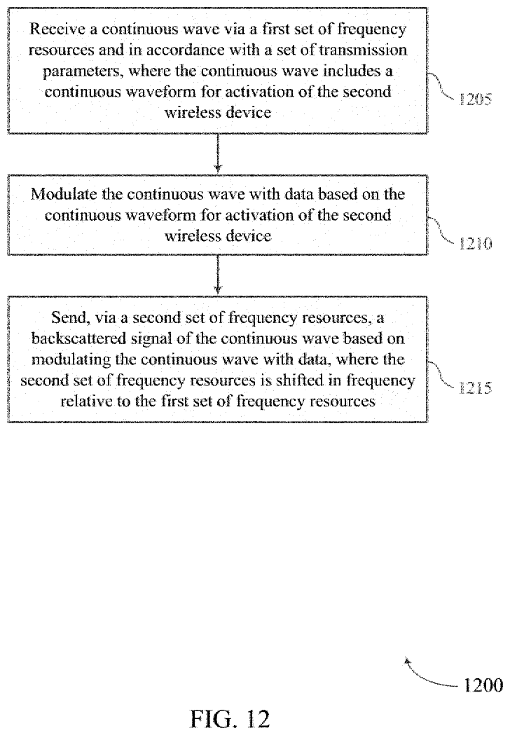

FIG. 12 illustrates a flowchart showing a method 1200 that supports frequency shifting in low power devices in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving a continuous wave via a first set of frequency resources and in accordance with a set of transmission parameters, where the continuous wave includes a continuous waveform for activation of the second wireless device. The operations of 1205 may be performed in accordance with examples as disclosed herein. In some examples, aspects of the operations of 1205 may be performed by a continuous wave component 825 as described with reference to FIG. 8.

At 1210, the method may include modulating the continuous wave with data based on the continuous waveform for activation of the second wireless device. The operations of 1210 may be performed in accordance with examples as disclosed herein. In some examples, aspects of the operations of 1210 may be performed by a modulation component 835 as described with reference to FIG. 8.

At 1215, the method may include sending, via a second set of frequency resources, a backscattered signal of the continuous wave based on modulating the continuous wave with data, where the second set of frequency resources is shifted in frequency relative to the first set of frequency resources. The operations of 1215 may be performed in accordance with examples as disclosed herein. In some examples, aspects of the operations of 1215 may be performed by a backscattered signal component 830 as described with reference to FIG. 8.

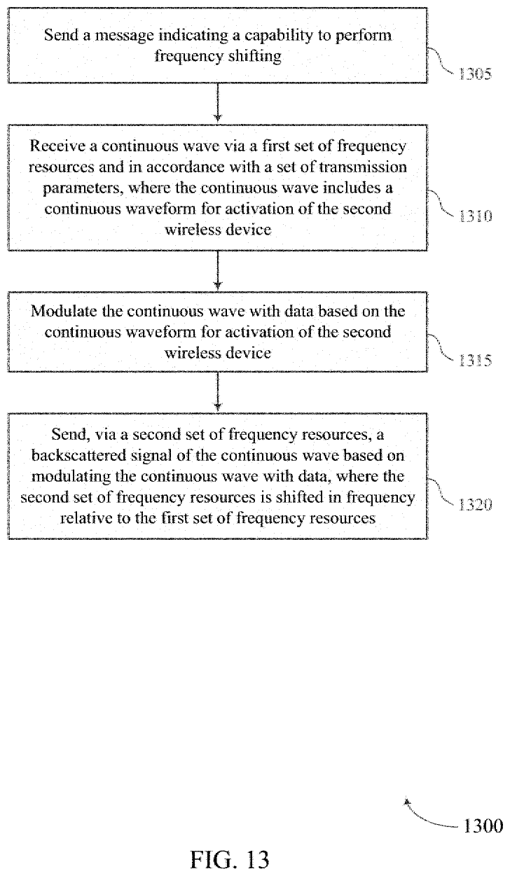

FIG. 13 illustrates a flowchart showing a method 1300 that supports frequency shifting in low power devices in accordance with one or more aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include sending a message indicating a capability to perform frequency shifting. The operations of 1305 may be performed in accordance with examples as disclosed herein. In some examples, aspects of the operations of 1305 may be performed by a capability component 845 as described with reference to FIG. 8.

At 1310, the method may include receiving a continuous wave via a first set of frequency resources and in accordance with a set of transmission parameters, where the continuous wave includes a continuous waveform for activation of the second wireless device. The operations of 1310 may be performed in accordance with examples as disclosed herein. In some examples, aspects of the operations of 1310 may be performed by a continuous wave component 825 as described with reference to FIG. 8.

At 1315, the method may include modulating the continuous wave with data based on the continuous waveform for activation of the second wireless device. The operations of 1315 may be performed in accordance with examples as disclosed herein. In some examples, aspects of the operations of 1315 may be performed by a modulation component 835 as described with reference to FIG. 8.

At 1320, the method may include sending, via a second set of frequency resources, a backscattered signal of the continuous wave based on modulating the continuous wave with data, where the second set of frequency resources is shifted in frequency relative to the first set of frequency resources. The operations of 1320 may be performed in accordance with examples as disclosed herein. In some examples, aspects of the operations of 1320 may be performed by a backscattered signal component 830 as described with reference to FIG. 8.

The following provides an overview of aspects of the present disclosure:
Aspect 1: A method for wireless communication at a first wireless device, comprising: transmitting, to a second wireless device, a continuous wave via a first set of frequency resources and in accordance with a set of transmission parameters, wherein the continuous wave comprises a continuous waveform for activation of the second wireless device; and receiving, from the second wireless device and via a second set of frequency resources, a backscattered signal of the continuous wave, wherein the second set of frequency resources is shifted in frequency relative to the first set of frequency resources.
Aspect 2: The method of aspect 1, further comprising: receiving, from a network entity, a message comprising an indication to communicate with the second wireless device, a quantity of RBs to use in the first set of frequency resources, a target transmission power, a target reception power, a classification of the second wireless device, or a combination thereof, wherein transmitting the continuous wave via the first set of frequency resources is based at least in part on the message.
Aspect 3: The method of any of aspects 1 through 2, further comprising: receiving a message comprising a capability of the second wireless device to perform frequency shifting, wherein receiving the backscattered signal via the second set of frequency resources shifted in frequency relative to the first set of frequency resources is based at least in part on the message.
Aspect 4: The method of any of aspects 1 through 3, further comprising: receiving a message indicating a frequency shift value of the second set of frequency resources, wherein the second set of frequency resources are shifted in frequency relative to the first set of frequency resources based at least in part on the frequency shift value.
Aspect 5: The method of any of aspects 1 through 4, further comprising: transmitting, to a third wireless device, an indication of the first set of frequency resources used for the continuous wave, a frequency shift value, or both.
Aspect 6: The method of any of aspects 1 through 5, further comprising: performing channel estimations on a channel between the first wireless device and the second wireless device based at least in part on the continuous wave; and performing time and frequency corrections to decode the backscattered signal based at least in part on performing the channel estimations.
Aspect 7: The method of any of aspects 1 through 6, wherein the first set of frequency resources are contiguous in frequency; and the second set of frequency resources are shifted in frequency relative to the first set of frequency resources by a frequency shift value that is greater than a quantity of RBs of the first set of frequency resources.
Aspect 8: The method of any of aspects 1 through 6, wherein the first set of frequency resources are non-contiguous in frequency; and the second set of frequency resources are shifted in frequency relative to the first set of frequency resources by a frequency shift value that is less than a spacing between RBs of the first set of frequency resources.
Aspect 9: The method of any of aspects 1 through 8, wherein a quantity of RBs in the first set of frequency resources is based at least in part on the set of transmission parameters, the set of transmission parameters comprise a target transmission power, a target reception power, a PSD constraint, or a combination thereof.
Aspect 10: The method of any of aspects 1 through 9, wherein a quantity of RBs in the first set of frequency resources is based at least in part on a classification of the second wireless device.
Aspect 11: The method of aspect 10, wherein the classification of the second wireless device comprises one of a passive classification, a semi-passive classification, a semi-active classification, or an active classification.
Aspect 12: The method of any of aspects 1 through 11, wherein the second set of frequency resources are shifted in frequency relative to the first set of frequency resources based at least in part on a frequency shift value, the frequency shift value is preconfigured at the first wireless device.
Aspect 13: A method for wireless communication at a second wireless device, comprising: receiving a continuous wave via a first set of frequency resources and in accordance with a set of transmission parameters, wherein the continuous wave comprises a continuous waveform for activation of the second wireless device; modulating the continuous wave with data based at least in part on the continuous waveform for activation of the second wireless device; and sending, via a second set of frequency resources, a backscattered signal of the continuous wave based at least in part on modulating the continuous wave with data, wherein the second set of frequency resources is shifted in frequency relative to the first set of frequency resources.
Aspect 14: The method of aspect 13, further comprising: sending a message indicating a capability to perform frequency shifting, wherein sending the backscattered signal via the second set of frequency resources shifted in frequency relative to the first set of frequency resources is based at least in part on the capability to perform the frequency shifting.
Aspect 15: The method of any of aspects 13 through 14, wherein the continuous wave is received from a first wireless device and the backscattered signal is sent to a third wireless device.
Aspect 16: The method of any of aspects 13 through 15, wherein the second set of frequency resources are shifted in frequency relative to the first set of frequency resources based at least in part on a frequency shift value.
Aspect 17: The method of any of aspects 13 through 16, wherein a quantity of RBs in the first set of frequency resources is based at least in part on the set of transmission parameters, the set of transmission parameters comprise a target transmission power, a target reception power, a PSD constraint, or a combination thereof.
Aspect 18: The method of any of aspects 13 through 17, wherein a quantity of RBs in the first set of frequency resources is based at least in part on a classification of the second wireless device.
Aspect 19: The method of aspect 18, wherein the classification of the second wireless device comprises one of a passive classification, a semi-passive classification, a semi-active classification, or an active classification.
Aspect 20: The method of any of aspects 13 through 19, wherein the first set of frequency resources are contiguous in frequency; and the second set of frequency resources are shifted in frequency relative to the first set of frequency resources by a frequency shift value that is greater than a quantity of RBs of the first set of frequency resources.
Aspect 21: The method of any of aspects 13 through 19, wherein the first set of frequency resources are non-contiguous in frequency; and the second set of frequency resources are shifted in frequency relative to the first set of frequency resources by a frequency shift value that is less than a spacing between RBs of the first set of frequency resources.
Aspect 22: An apparatus for wireless communication at a first wireless device, comprising a processor; memory coupled with the processor; and instructions stored in the memory and executable by the processor to cause the apparatus to perform a method of any of aspects 1 through 12.
Aspect 23: An apparatus for wireless communication at a first wireless device, comprising at least one means for performing a method of any of aspects 1 through 12.
Aspect 24: A non-transitory computer-readable medium storing code for wireless communication at a first wireless device, the code comprising instructions executable by a processor to perform a method of any of aspects 1 through 12.
Aspect 25: An apparatus for wireless communication at a second wireless device, comprising a processor; memory coupled with the processor; and instructions stored in the memory and executable by the processor to cause the apparatus to perform a method of any of aspects 13 through 21.
Aspect 26: An apparatus for wireless communication at a second wireless device, comprising at least one means for performing a method of any of aspects 13 through 21.
Aspect 27: A non-transitory computer-readable medium storing code for wireless communication at a second wireless device, the code comprising instructions executable by a processor to perform a method of any of aspects 13 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a first wireless device, comprising:
a memory; and
a processor coupled to the memory and configured to:
transmit, to a second wireless device, a continuous wave via a first set of frequency resources and in accordance with a set of transmission parameters, wherein the continuous wave comprises a continuous waveform for activation of the second wireless device; and
receive, from the second wireless device and via a second set of frequency resources, a backscattered signal of the continuous wave, wherein the second set of frequency resources is shifted in frequency relative to the first set of frequency resources.

2. The apparatus of claim 1, wherein the processor is further configured to:
receive, from a network entity, a message comprising an indication to communicate with the second wireless device, a quantity of resource blocks to use in the first set of frequency resources, a target transmission power, a target reception power, a classification of the second wireless device, or a combination thereof, wherein transmitting the continuous wave via the first set of frequency resources is based at least in part on the message.

3. The apparatus of claim 1, wherein the processor is further configured to:
receive a message comprising a capability of the second wireless device to perform frequency shifting, wherein receiving the backscattered signal via the second set of frequency resources shifted in frequency relative to the first set of frequency resources is based at least in part on the message.

4. The apparatus of claim 1, wherein the processor is further configured to:
receive a message indicating a frequency shift value of the second set of frequency resources, wherein the second set of frequency resources are shifted in frequency relative to the first set of frequency resources based at least in part on the frequency shift value.

5. The apparatus of claim 1, wherein the processor is further configured to:
transmit, to a third wireless device, an indication of the first set of frequency resources used for the continuous wave, a frequency shift value, or both.

6. The apparatus of claim 1, wherein the processor is further configured to:
perform channel estimations on a channel between the first wireless device and the second wireless device based at least in part on the continuous wave; and
perform time and frequency corrections to decode the backscattered signal based at least in part on performing the channel estimations.

7. The apparatus of claim 1, wherein:
the first set of frequency resources are contiguous in frequency; and
the second set of frequency resources are shifted in frequency relative to the first set of frequency resources by a frequency shift value that is greater than a quantity of resource blocks of the first set of frequency resources.

8. The apparatus of claim 1, wherein:
the first set of frequency resources are non-contiguous in frequency; and
the second set of frequency resources are shifted in frequency relative to the first set of frequency resources by a frequency shift value that is less than a spacing between resource blocks of the first set of frequency resources.

9. The apparatus of claim 1, wherein:
a quantity of resource blocks in the first set of frequency resources is based at least in part on the set of transmission parameters, the set of transmission parameters comprising a target transmission power, a target reception power, a power spectral density constraint, or a combination thereof.

10. (canceled)

11. The apparatus of claim 10, wherein a quantity of resource blocks in the first set of frequency resources is based at least in part on a classification of the second wireless device, and wherein the classification of the second wireless device comprises one of a passive classification, a semi-passive classification, a semi-active classification, or an active classification.

12. The apparatus of claim 1, wherein the second set of frequency resources are shifted in frequency relative to the first set of frequency resources based at least in part on a frequency shift value, the frequency shift value being preconfigured at the first wireless device.

13. An apparatus for wireless communication at a second wireless device, comprising:
a memory; and
a processor coupled to the memory and configured to:
receive a continuous wave via a first set of frequency resources and in accordance with a set of transmission parameters, wherein the continuous wave comprises a continuous waveform for activation of the second wireless device;
modulate the continuous wave with data based at least in part on the continuous waveform for activation of the second wireless device; and
send, via a second set of frequency resources, a backscattered signal of the continuous wave based at least in part on modulating the continuous wave with data, wherein the second set of frequency resources is shifted in frequency relative to the first set of frequency resources.

14. The apparatus of claim 13, wherein the processor is further configured to:
send a message indicating a capability to perform frequency shifting, wherein sending the backscattered signal via the second set of frequency resources shifted in frequency relative to the first set of frequency resources is based at least in part on the capability to perform the frequency shifting.

15. The apparatus of claim 13, wherein the continuous wave is received from a first wireless device and the backscattered signal is sent to a third wireless device.

16. The apparatus of claim 13, wherein the second set of frequency resources are shifted in frequency relative to the first set of frequency resources based at least in part on a frequency shift value.

17. The apparatus of claim 13, wherein:
a quantity of resource blocks in the first set of frequency resources is based at least in part on the set of transmission parameters, the set of transmission parameters comprising a target transmission power, a target reception power, a power spectral density constraint, or a combination thereof.

18-19. (canceled)

20. The apparatus of claim 13, wherein:
the first set of frequency resources are contiguous in frequency; and
the second set of frequency resources are shifted in frequency relative to the first set of frequency resources by a frequency shift value that is greater than a quantity of resource blocks of the first set of frequency resources.

21. The apparatus of claim 13, wherein:
the first set of frequency resources are non-contiguous in frequency; and
the second set of frequency resources are shifted in frequency relative to the first set of frequency resources by a frequency shift value that is less than a spacing between resource blocks of the first set of frequency resources.

22. A method for wireless communication at a first wireless device, comprising:
transmitting, to a second wireless device, a continuous wave via a first set of frequency resources and in accordance with a set of transmission parameters, wherein the continuous wave comprises a continuous waveform for activation of the second wireless device; and
receiving, from the second wireless device and via a second set of frequency resources, a backscattered signal of the continuous wave, wherein the second set of frequency resources is shifted in frequency relative to the first set of frequency resources.

23.-30. (canceled)
